(19) United States
(12) Patent Application Publication
(10) Pub. No.: US 2006/0101110 A1
(43) Pub. Date: May 11, 2006

(54) Data interchange device

(76) Inventor: Michael Grossman, Toronto (CA)

Correspondence Address: CAHN & SAMUELS LLP, 2000 P STREET NW, SUITE 200, WASHINGTON, DC, 20036, US

(21) Appl. No.: 10/963,806

(22) Filed: Oct. 14, 2004

(51) Int. Cl. G06F 15/16

(52) U.S. Cl. 709/200

(57) ABSTRACT

A data interchange device exchanges data objects with a computing device using wireless data transmission, and has a CPU; a memory, a trigger device, a wireless data transmitter and receiver, and a user signalling device. Upon activation, the CPU causes the user signalling device to indicate that the data interchange device is operative, and wireless data transmission with a computing device occurs, so that a data object is retrieved from or stored in memory. Upon completion of wireless data transmission, or after passage of a predetermined period of wireless data transmission inactivity, the CPU causes the user signalling device to turn off. Typically, there is also at least one hard-wired input port for receiving data objects from an external computing device for storage in the memory. Use of the data interchange device is one-on-one by a person who must be in close proximity to the device.

### I. FIELD OF THE INVENTION

This invention relates to data exchange, and particularly the present invention relates to wireless data interchange whereby data may be transmitted using wireless transmission protocols between a data interchange device and a computing device. Typically, although not necessarily, the computing device is a mobile device; and typically, although not necessarily, the data interchange device is stationary.

### II. BACKGROUND OF THE INVENTION

Many people carry mobile computing devices of the sort typically referred to as Personal Digital Assistants (PDA), which they use for many purposes of scheduling their time, contact information, and the like. Other mobile computing devices are also in use which may serve a number of the same purposes, although typically the present invention is directed to the use of PDAs. One feature of any such mobile computing device is that they are capable of transmitting and receiving data using wireless transmission protocols. Another feature is that such mobile computing devices typically are capable of receiving, storing, and transmitting data which is formatted with a predefined format such that contact information, calendar information, and so on, can be accessed, modified, deleted, or added to, easily and in meaningful fashion.

For purposes of the present discussion, several definitions must be understood. The first is the meaning of the phrase “data object”, which is spoken of and is meant to be understood to mean a block of data which is formatted in a known, although not necessarily common, format. Examples of such data objects are “VCard” (Virtual business Card), “VCal” (Virtual Calendar entry), XML (Extensible Markup Language), and text entries. Still further, a data object may contain a macro substitution code, as discussed hereafter.

Another phrase for which an understanding of the manner in which it is used herein is “substitution object”. A substitution object is typically a keyword/value pair which contains a name and a substitution value for that name. Thus, as discussed hereafter, any data object which is to be transmitted from the data interchange device of the present invention may be modified in keeping with specific instructions according to any relevant substitution object.

It also has to be understood that wireless transmission protocols may typically employ radio frequency transmissions, having very low power and therefore very low range, and light frequencies—typically, infrared. Thus, several well-known wireless transmission protocols are particularly contemplated, because each of them is applicable in one way or another to a PDA, either singly or in any combination. Those wireless transmission protocols include IrDA, BlueTooth, or WiFi. The specifications for these protocols are beyond the scope of the present invention.

Several typical purposes for the present invention include the interchange of business card information, the interchange of schedule or appointment information, and the interchange of retail promotion or advertising data, including discount coupons and the like. It will be assumed for purposes of the present discussion that the individual user—that is to say, a person who, at any one time, is within transmission range of a data interchange device in keeping with the present invention—is a person who carries a PDA; although in some instances as described hereafter, that person may simply employ a keychain dongle.

Several typical scenarios for use the present invention may be as follows: an individual visits the office of a professional such as a doctor, lawyer, or accountant, and wishes to enter the contact information for that professional into his PDA. If the professional has a data interchange device in keeping with the present invention on his desk, the visitor may simply point his PDA at the data interchange device—which may take the form of a business card holder, for example—and press a button on the device whereby a data object in the form of a VCard is transmitted by wireless transmission protocol to the PDA. Another example is that of a person carrying a PDA who passes an advertising display advertising, for example, an upcoming concert. The person again points his PDA at the advertisement and presses a button on the advertising display which is associated with a data interchange device in keeping with the present invention and which is integrated with the advertising display, so that VCal or other data objects may be transferred to the PDA, as they relate to that upcoming concert.

Yet another example is that of the person who leaves a film for processing, or clothes for laundering or dry-cleaning, and who again presses a button on a data interchange device at the film processing or dry-cleaning establishment after the attending clerk has entered the pickup data and receipt for the goods into the data interchange device—or into a computer which will input the requisite data to the data interchange device—whereby the necessary reminder to pick up the processed film or clothes at the time when they are ready is entered into the PDA.

A still further example of the use of data interchange devices of the present invention is to advise the public, or any member of the public who carries a PDA in particular, of access times for public recreation facilities such as hockey and skating rinks, swimming pools, and the like. Often, a member of the public wishes to know when such a facility may be open for the public to use, and such data will vary according to season and perhaps other local conditions such as unseasonable weather, religious or public holidays, and so on. In each instance, it is possible for a specific data interchange device associated with any such public facility to be updated as to its public access information from a central municipal authority by transmitting the current data either wirelessly or through a hardwire connection, as described hereafter. Nonetheless, the appropriate and up-to-date information is available to be downloaded to any PDA of any person at any time, who is in close proximity to the recreation facility.

In order to achieve these goals, the present invention provides a data interchange device which includes a central processing unit, memory, and wireless transmission facilities, so that upon activation data interchange occurs whereby a data object may be retrieved from or stored in the memory of the data interchange device. More specific definitions of the various components which comprise a data interchange device in keeping with the present invention are described hereafter. The data interchange device of the present invention is intended to provide for interchange of data using wireless data transmission with a computing device. Typically, the computing device is a mobile computing device and the data interchange device is stationary; although in some instances, it is possible that the data interchange device may be in the form of a dongle and the computing device is stationary.

From the above, it will be to the understood that operation of data interchange devices in keeping with the present invention requires the intervention of only a single person, typically one who is carrying a mobile computing device such as a PDA, and who will exchange data with a stationary data interchange device extemporaneously. This is in contradistinction to the exchange of data between two PDAs, where typically each respective PDA owner must be present and must initiate operation of a data interchange protocol on each respective PDA. This is also in contradistinction with downloading of information or data from the Internet, which typically requires a hardwire connection and which is not, in any event, visually initiated by the physical presence of a person wishing to interchange data to or from a device which is in close physical proximity to that person.

### III. DESCRIPTION OF THE PRIOR ART

U.S. Pat. No. 6,463,463, issued Oct. 8, 2002, describes a system and method whereby information may be pushed from a host system to a mobile communication device. In this case, a triggering event must be sensed, and a redirector program is effective at the host system to enable a user to continuously redirect calendar event messages.

The memorialization of commercial transactions via an electronic receipt is described in United States Patent Application Publication 2003/0055733. Specifically, a connection is established between a mobile device and an electronic receipt terminal so that the electronic receipt may be transmitted to the mobile device.

Another United States Patent Application Publication that describes an electronic transaction receipt system is 2001/0029483, which discusses an electronic receipt being issued to the buyer at the time of a sales transaction, where the electronic receipt includes hyperlinks. Various data can be associated with the hyperlink for post-sale interaction with the product's seller, the manufacturer, or any other party that involves the product itself, whereby such matters as a product return procedure, a product warranty procedure, rebate notices and recall notices, and the like, can be facilitated.

United States Patent Application Publication 2003/0216954 describes a method and system for providing marketing accountability whereby a plurality of handhold communicators which contain signature information pertaining to an individual associated with each device is provided, and one or more data push devices are provided and configured to perform information exchange with the plurality of handheld communicators and to receive the signature information contained therein. This provides means whereby a central information management source can compile marketing accountability information based on the signature information obtained from the plurality of handheld communicators.

A system which provides interactive communications for portable computing devices using short-range communications is described in United States Patent Application Publication 2003/0165128. Here, there is described a system which permits data and programs to be exchanged between an access point data terminal device and nearby portable computing devices. The data and program installation mechanism on the access point is manually operable by any user when that user is positioned near the access point with a portable computing device, so as to download and install application software which programs the portable computing device to utilize the services which are available at that access point.

U.S. Pat. No. 6,701,378, issued Mar. 2, 2004, describes a system and method for pushing information from a host system to a mobile data communication device when a triggering event is sensed. A redirector program at the host system operates in connection with event-generating applications and repackaging systems to configure and detect a particular user-defined event, so that the user-selected data items in an electronic wrapper are repackaged and then pushed to the mobile device.

### IV. SUMMARY OF THE INVENTION

In accordance with one aspect of the present invention, there is provided a data interchange device which is intended for use in association with a computing device, so that a single user may unilaterally cause data objects to be transmitted at any time using wireless data transmission between the data interchange device and a single computing device.

The data interchange device comprises a central processing unit, a memory having volatile and non-volatile memory capacity, and at least one trigger device to initiate operation of the data interchange device.

There is a wireless data transmitter and a wireless data receiver, which may be combined as a transceiver.

At least one user signalling device is provided,

Upon activation of the at least one trigger device, the central processing unit will cause the user signalling device to indicate that the data interchange device is operative, and wireless data transmission between either the transmitter or the receiver and a single computing device will then occur, so that a data object may be retrieved from or stored in the memory.

Upon completion of the wireless data transmission, or after passage of a predetermined period of wireless data transmission inactivity, the central processing unit causes the user signalling device to turn off.

The data interchange device of the present invention will typically further comprise at least one hard-wired input port for receiving data objects from an external computing device for storage in the memory.

Such data interchange device may be configured to transmit data to a mobile computing device upon request by activating the at least one trigger device, and to receive and update data objects via either wireless data transmission or through the at least one hard-wired input port.

A data interchange device in keeping with the present invention typically functions with the wireless data transmission to and from the device being chosen from the group of wireless data transmission technologies which consists of IrDA, BlueTooth, WiFi, and combinations thereof.

The at least one user signalling device which indicates that the data interchange device is operative is typically chosen from the group which consists of light output devices, sound output devices, vibration devices, and combinations thereof.

Each data object which may be transmitted to or from the data interchange device is typically a block of data in a predefined format.

Such predefined formats are typically chosen from the group which consists of VCard, VCal, XML, text, and combinations thereof.

The memory may contain substitution objects in the form of keyword/value pairs, so that any data object to be transmitted from the data interchange device may be modified in keeping with a specific instruction according to any relevant substitution object.

Moreover, any data object may contain a macro substitution code so that specific data from a specific memory location, or from a peripheral data module associated with the central processing unit, may be inserted at a specific place in the data block when it is being transmitted from the data interchange device.

If so, a typical peripheral data module may be chosen from the group which consists of a clock, whereby time of day data may be substituted in the data block, a calendar, whereby day of month data may be substituted in the data block, shift registers to add specific intervals to the instantaneous time of day or day of month data to be substituted, and combinations thereof.

A hard-wired input port which may be provided for a data interchange device in keeping with present invention may be chosen from the group consisting of a USB port, an RS-232 port, an EtherNet port, and combinations thereof.

Moreover, the data interchange device may further include a hard-wired port adapted for communication with a peripheral reader device which may be such as an RFID tag reader, a bar code reader, a matrix code reader, a magnetic stripe reader, a biometrics reader, and combinations thereof.

The trigger device for a data interchange device in keeping with present invention may be chosen from the group which consists of mechanical switches, buttons, electronic signalling devices, solid-state switches, proximity switches, and combinations thereof.

A data interchange device in keeping with the present invention is typically configured to receive and store data objects from a mobile computing device upon request by activating the at least one trigger device, and to transfer data objects to a computing device via wireless data transmission or through a hard-wired output port.

### V. BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a block schematic of a data interchange device in keeping with present invention, showing each of the functional components which comprise the data interchange device.

### VI. DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

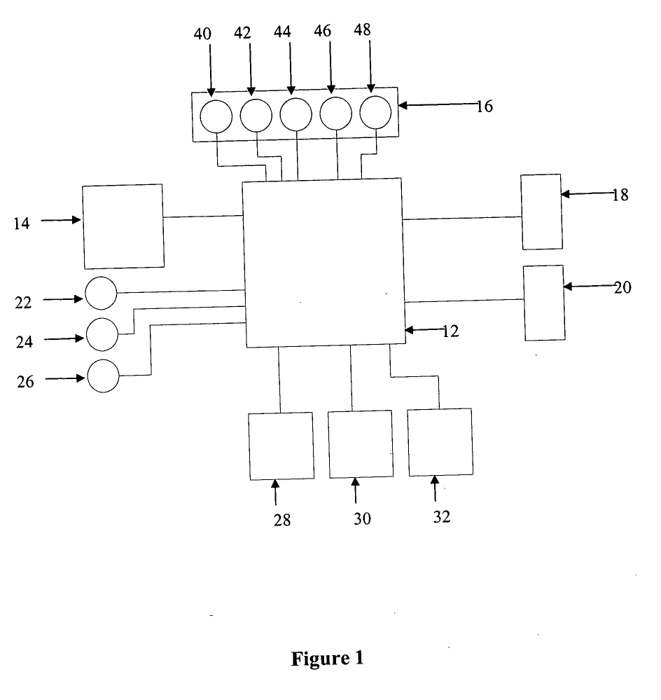

Referring to FIG. 1, the block schematic diagram of the data interchange device 10 is shown. The principal components of the data interchange device circuitry include a central processing unit or CPU 12, and a memory block 14. It will be understood, particularly from the discussion which follows, that the memory block 14 will have both volatile and non-volatile memory capacity. As well, as will be discussed hereafter, associated with the CPU 12 and/or memory block 14 there may be additional modules of the sort typically found in any computing device such as a clock module and a calendar module, whereby time of day and day of month data can be obtained. A shift register or other module may also be provided so that specific intervals may be added to the instantaneous time of day or day of month data, all for purposes to be described hereafter.

Other components of the data interchange device 10 that are shown in FIG. 1 include at least one trigger device 16, the particulars of which are also discussed hereafter. A wireless transmitter 18 and a wireless receiver 20 are located within the configuration of the data interchange device 10; and will be understood, of course, that the transmitter 18 and receiver 20 may be configured as a transceiver (not shown).

Also shown in the schematic block diagram of FIG. 1 are a plurality of user signalling devices, at least one of which will be present in any configuration of the data interchange device. They include signal output devices such as a lamp or LED 22, a sound output device 24, and a vibration device 26. Any one of those user signalling devices will operate at such time as the data interchange device is operating, so as to indicate that fact, as described hereafter.

Typically, a data interchange device in keeping with the present invention may also be configured with at least one hard-wired input port such as a USB input port 28, an RS-232 input port 30, or an EtherNet port 32.

The at least one trigger device 16 might be such as a mechanical switch 40, a button 42, an electronic signalling device 44, a solid-state switch 46, or a proximity switch 48. It will be understood that activation of the data interchange device will come about by activation of any one of the triggering devices, or the at least one trigger device 16. When operation of the data interchange device 10 is initiated by activation of the at least one trigger device 16, the fact that it is in the operation will then be evident from operation of at least one user signalling device 22, 24, 26, whereby a visual output of light from a lamp or LED will be seen, an output sound such as a chirp or buzz may be heard, or the device or a portion of it may vibrate. In any event, operation of the user signalling device continues while wireless data transmission is proceeding; and following completion of the wireless transmission, or after the passage of a predetermined period of wireless data transmission inactivity, the CPU 12 will cause the user signalling device 22, 24, 26 to turn off and the data interchange device 10 will revert to standby mode.

While the data interchange device 10 is activated, the CPU 12 will also control operation of the transmitter 18 or receiver 20, depending on whether the data interchange device is in a transmit mode or receive mode. In any event, while it is operating, a data object, or a plurality of data objects, will either be transmitted or received, which means that they will have been retrieved from or stored in the memory 14.

Thus, activation of a trigger device will cause a data object to be transmitted via wireless data transmission technology, or it may cause a data object to be received either via wireless data transmission technology or via a hard-wired input port.

The CPU 12 must be capable of detecting when any trigger device or system activation component changes its state, thereby indicating that a transmit or receive activity is desired. Of course, the CPU 12 is capable of interacting with whatever transmitter 18 and receiver 20 (or transceiver) is installed in the data interchange device; and the CPU must be capable of interacting with the memory module 14 and any memory components that are found therein.

The memory 14 has the capacity to hold at least several data objects which may be distributed from the data interchange device. The memory 14 will also hold a table of substitution objects in the form of keyword/value pairs. They may be such as time or date specific information which is to be substituted into the data object to be transmitted, advertising “carry along” information which will be added to the data object to be transmitted, or object expiry dates and post-expiry date substitution data.

As far as the transmitter 18 is concerned, it must be capable of interacting with any mobile computing device such as a PDA, a laptop computer, a mobile telephone, or another data interchange device in keeping with the present invention. As noted, the transmission is wireless and typically is in keeping with certain known technologies including particularly IrDA, BlueTooth, and WiFi.

Likewise, the receiver 20 must be capable of interacting with other computing devices which may or may not be mobile, including PDAs, laptop computers, desktop computers, wireless telephones, other data interchange device is, and so on. The same wireless transmission technologies may also be employed; and as well, the receiver must be capable of receiving data via any one of the hard-wired input ports 28, 30, 32.

Alternative input devices may also be employed either through a separate port or through one of the hard-wired ports 28, 30 in particular. Such alternative input devices include RFID tag readers, barcode readers, matrix card readers, magnetic stripe readers, biometric readers, and the like.

If the data interchange device of the present invention goes into a “transmit” mode upon activation of any of the trigger devices 16, then first the CPU will activate one of the user signalling devices 22, 24, 26. The CPU 12 then accesses the memory 14 and retrieves the appropriate data object, which might be modified according to several rules including the necessity to insert time of day and/or day of month data, carry along advertising, or object expiry/object substitution data. The CPU 12 then sends the data object, which may have been modified as noted immediately above, through the wireless transmitter 18 which functions in one of the wireless transmission technologies available to it. When the data object has been transmitted, or in the event of failure of data object transmission after passage of a predetermined period of time, the CPU 12 will deactivate the user signalling device 22, 24, 26, and the data interchange device will go into standby mode.

The data interchange device in the present invention may receive a single data object, or it may be activated to receive multiple data objects, via wireless transmission technology. If so, then once again a user signalling device 22, 24, 26 is activated, and the CPU 12 will activate the receiver 20. If the data object arrives within a reasonable period of time, the CPU will cause the data object—which may also be a substitution object as well as a data object—into the next available memory location. Upon success, the processor will deactivate the user signaling device 22, 24, 26, and the data interchange device will again go into standby mode. Also, as before, if the object has not arrived within a reasonable period of time, the CPU 12 will signal that a failure has occurred by appropriate activation of a user signalling device, and the data interchange device will then go into standby mode.

If data arrives via one of the hard-wired input ports, or an alternative input device, then once again after the complete object arrives—which may be a data object or a substitution object—within a reasonable period of time, the CPU 12 will cause the object to be stored in an appropriate memory location in the memory 14, and the shutdown procedure as described above will follow.

When a data interchange device in keeping with the present invention is first being set up, the operator of the device will connect it using either wireless transmission technology or through a hard-wired input port to a computing device of some sort, such as a laptop or desktop computer or a PDA. The operator would have created one or more data objects which correspond to the data objects to be distributed by the data interchange device. Within any data object there may be several macro substitution codes such as, for example, ${DATE} or ${${DATE}+3}. Such macro substitution code will thereby instruct the data interchange device that when the data object is to be dispensed, the information being dispensed is also to be updated with information concerning the current date; or in the example shown, with information concerning the current date plus three days. As it happens, such data objects are relatively easily created using PDAs, and are created simply through the process of creating a card file entry or a calendar entry.

The data object is then transferred into the data interchange device in the manner described above, and is stored unchanged in the data interchange device.

However, at the time when the data object is to be dispensed, that is when the data object is to be transmitted to any person requesting the same and who activates the data interchange device, the requested data object is copied into working memory of the data interchange device. Then, any macro substitution codes are removed and replaced with the appropriate information, after which the data object is sent to the requester using the appropriate wireless data transmission technology.

Thus, it will be understood that typical installations of data interchange device in keeping with the present invention may be such as a simple desktop business card holder, or a simple black box associated with an advertising sign or in a retail store display window. Other such uses include service industries where goods are left to be retrieved at a later date.

For example, as noted above, a professional person may have a business card holder from which cardboard cards are available to those who want them, but which would also include at least one button and one signalling device such as a lamp or LED, whereby the visitor to that professional can electronically download the business card information to such as a PDA. A retail store might have a display in its window inviting passers-by to press a button available near the display, or possibly even to approach within very close proximity of the display in the event of the use of a proximity switch to activate the data interchange device, whereby data concerning the goods or services being displayed may be downloaded into an interested person's PDA. Such data may also include discount coupons and the like.

Of course, it is also recognized that certain persons may not wish to carry such as a PDA but may have a keychain dongle in their pocket having certain personal information stored therein. Those persons could, in the right circumstances, transfer that data to a data interchange device whereby the operator of the data interchange device would then have data concerning an interested person who might wish to be called later for discussion of the goods or services being advertised.

Several examples of typical uses of the data interchange device of the present invention now follow:

### EXAMPLE 1

An individual who carries a PDA, or other mobile computing device, may pass an advertising panel along the street, in a subway station, or the like, where the panel is advertising goods or services in which that person is interested. A data interchange device in keeping with the present invention is mounted at the edge of the advertising panel, and has been preprogrammed with information such as the location of the nearest store where the advertised product or service may be obtained, or the date, time, and place of an upcoming event and an indication as to where tickets may be purchased, and so on. The individual accesses their PDA, points it at the display advertising, and presses an appropriate button or activates an appropriate switch on the display advertising to transmit the data that that individual wants into the PDA. It may be that the advertising display may have several goods or services being advertised, and several switches for the various goods or services, whereby specific data regarding a specific product or service may be downloaded into the respective PDA, or other mobile computing device, of the interested individual.

### EXAMPLE 2

An individual carrying a PDA passes by a store window which has interesting goods or services being displayed for sale. The store, however, is closed. A data interchange device in keeping with the present invention is mounted on the door or window of the store, and has been preprogrammed with the appropriate store contact information or specific information with respect to the goods or services of interest to the passer-by. Once again, the individual may access their PDA, press an appropriate button on the data interchange device mounted at the door or window of the store, and transmit the necessary information to the PDA.

### EXAMPLE 3

An individual who carries a PDA drops off a roll of film to be processed at the appropriate establishment. The clerk promises to have the film processed and prints ready in three days. Here, the clerk enters the necessary receipt and date data either into a data interchange device which is on the counter at the establishment, or into a computer which is connected to the data interchange device. A VCal reminder template is preprogrammed in the data interchange device. After the clerk has scanned the film processing envelope to extract the barcode, it is then transferred into the data interchange device via a hard-wire connection. Thereafter, the individual pushes the appropriate button or activates the necessary switch on the data interchange device on the counter top, and the stored VCal entry in the data interchange device is modified based on the current date and time, plus three days; and the supplied barcode data is also noted. The thus modified data object with all of the date and other retrieval data is then transferred into the individual's PDA via the then active wireless transmission technology. It is understood that the PDA already has the necessary calendaring software which is capable of storing and retrieving that entry appropriately.

### EXAMPLE 4

In this case, a passer-by is either carrying a data interchange device in keeping with the present invention, or a keychain dongle which has wireless transmission capabilities. The individual notes a display or advertisement for goods or services of interest, and it happens that the display or advertisement is also equipped with a data interchange device in keeping with the present invention. The display or advertisement has a button which activates it to receive information from a third-party or specifically from a device capable of transmitting a data object. Upon activating the display or advertisement to receive a data object, and upon activating the keychain dongle to transmit a data object, the data object which typically provides contact information for that individual is transmitted to the display or advertisement. That data object is retrieved at a later time by the operator of the display or advertisement, who may then initiate telephone or e-mail correspondence with all of the interested passers-by who have provided their individual data objects to the data interchange device operated by the owner of the display or advertisement.

There has been described a data interchange device whose purpose is to permit wireless interchange of data objects with individuals on a one-on-one basis. Each individual who receives a data object (or in some instances, who transmits a data object) from or to the data interchange device must be in close physical proximity with the data interchange device. However, data objects intended be transmitted by the data interchange device may be deleted, changed, or updated either by wireless or hard-wire transmission. Data objects stored in keeping with templates in the data interchange device may be modified in keeping with substitution objects, all as described above.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of components or steps but not to the exclusion of any other integer or step or group of components or steps.

Moreover, use of the terms “he”, “him”, or “his”, is not intended to be specifically directed to persons of the masculine gender, and could easily be read as “she”, “her”, or “hers”, respectively.

What is claimed is:

1. A data interchange device for use in association with a computing device, whereby a single user may unilaterally cause data objects to be transmitted at any time using wireless data transmission between said data interchange device and a single computing device; wherein said data interchange device comprises:
a central processing unit;
a memory having volatile and non-volatile memory capacity;
at least one trigger device to initiate operation of said data interchange device;
a wireless data transmitter;
a wireless data receiver; and
at least one user signalling device;
wherein, upon activation of said at least one trigger device said central processing unit causes said user signalling device to indicate that the data interchange device is operative, and wireless data transmission between either said transmitter or said receiver and a single computing device occurs, whereby a data object is retrieved from or stored in said memory; and
wherein, upon completion of said wireless data transmission, or after passage of a predetermined period of wireless data transmission inactivity, said central processing unit causes said user signalling device to turn off.

2. The data interchange device of claim 1, further comprising at least one hard-wired input port for receiving data objects from an external computing device for storage in said memory.

3. The data interchange device of claim 2, wherein said data interchange device is configured to transmit data to a mobile computing device upon request by activating said at least one trigger device, and to receive and update data objects via wireless data transmission or through said at least one hard-wired input port.

4. The data interchange device of claim 1, wherein wireless data transmission to and from said data interchange device may be chosen from the group of wireless data transmission technologies consisting of IrDA, BlueTooth, WiFi, and combinations thereof.

5. The data interchange device of claim 1, wherein said at least one user signalling device is chosen from the group consisting of light output devices, sound output devices, vibration devices, and combinations thereof.

6. The data interchange device of claim 1, wherein said data object is a block of data in a predefined format.

7. The data interchange device of claim 6, wherein said predefined format is chosen from the group consisting of VCard, VCal, XML, text, and combinations thereof.

8. The data interchange device of claim 6, wherein said memory contains substitution objects in the form of keyword/value pairs, whereby any data object to be transmitted from said data interchange device may be modified in keeping with a specific instruction according to any relevant substitution object.

9. The data interchange device of claim 6, wherein any data object may contain a macro substitution code whereby specific data from a specific memory location or from a peripheral data module associated with said central processing unit may be inserted at a specific place in the data block when it is being transmitted from said data interchange device.

10. The data interchange device of claim 9, wherein said peripheral data module is chosen from the group consisting of a clock, whereby time of day data may be substituted in said data block, a calendar, whereby day of month data may be substituted in said data block, shift registers to add specific intervals to the instantaneous time of day or day of month data to be substituted, and combinations thereof.

11. The data interchange device of claim 2, wherein said hard-wired input port is chosen from the group consisting of a USB port, an RS-232 port, an EtherNet port, and combinations thereof.

12. The data interchange device of claim 11, wherein said data interchange device further includes a hard-wired port adapted for communication with a peripheral reader device chosen from the group consisting of an RFID tag reader, a bar code reader, a matrix code reader, a magnetic stripe reader, a biometrics reader, and combinations thereof.

13. The data interchange device of claim 1, wherein said at least one trigger device is chosen from the group consisting of mechanical switches, buttons, electronic signalling devices, solid state switches, proximity switches, and combinations thereof.

14. The data interchange device of claim 2, wherein said data interchange device is configured to receive and store data objects from a mobile computing device upon request by activating said at least one trigger device, and to transfer said data objects to a computing device via wireless data transmission or through a hard-wired output port.

15. The data interchange device of claim 1, wherein said wireless data transmitter and said wireless data receiver are configured as a wireless data transceiver.
